(19) United States
(12) Patent Application Publication
(10) Pub. No.: US 2026/0175457 A1
(43) Pub. Date: Jun. 25, 2026

(54) SHAVING DEVICE WITH HAIR REMOVAL FEATURES

(71) Applicant: WAHL CLIPPER CORPORATION, Sterling, IL (US)

(72) Inventor: Gary Lee SNOW, Rock Falls, IL (US)

(21) Appl. No.: 19/367,187

(22) Filed: Oct. 23, 2025

Related U.S. Application Data
(60) Provisional application No. 63/736,171, filed on Dec. 19, 2024.

(51) Int. Cl. B26B 19/04; B26B 19/38; B26B 19/06

(52) U.S. Cl. CPC B26B 19/048; B26B 19/386; B26B 19/063

(57) ABSTRACT

An Electric Shaver With Cleaning Features includes a housing and a motor carried by the housing. A drive linkage is operably connected to the motor to transfer a mechanical load from the motor. A cutting is head situated at an end of the housing and operably connected to the drive linkage to produce a hair cutting action. The cutting head includes at least one cutting assembly. The at least one cutting assembly includes an outer cutter defining a passageway extending along a longitudinal axis. The cutting assembly also includes an inner cutter movable within the passageway in a cutting direction parallel to the longitudinal axis of the passageway to produce the hair cutting action. The passageway extends through the cutting head to define a drainage flow path for a fluid passing through the passageway in a direction parallel to the cutting direction.

### RELATED APPLICATION

The present application claims the benefit under 35 USC 119(e) of US Provisional Application No. 63/736,171 filed Dec. 19, 2024, the entire contents of which are incorporated by reference herein.

### BACKGROUND

The present invention relates generally to electric hair cutting devices, and more specifically to electric shavers configured to cut hair as the electric shaver is moved across a user’s skin.

Electric shavers generally include one or more cutting assemblies that consist of a stationary outer cutter, and a movable inner cutter. The inner cutter is arranged to move relative to the outer cutter to produce a hair cutting action. So called rotary shavers include one or more circular, perforated outer cutters which enclose a rotatably mounted inner cutter. So called foil shavers include one or more linear outer cutters which enclose a generally linear inner cutter which linearly reciprocates relative to the outer cutter.

While the cutting motion of rotary and foil shavers differs, the general principle of hair cutting action offered by the two is the same. In general, hair extends through openings in the outer cutter into an area within which the inner cutter is moving. The openings are typically formed through a cutting element of the outer cutter. The cutting element is typically a metal foil structure. The cutting surfaces of the inner cutter cooperate with the openings of the cutting element of the outer cutter to effectively cut hair where it extends through the openings of the outer cutter in a shearing action.

Cut hair accumulates in the region of the inner cutter in both rotary and foil shavers. In rotary shavers, the same may incorporate mechanical features which expose the space in which the cut hair is collected. This cut hair may be cleaned out between operations. Typical rotary shavers include several cutting assemblies, and the space in which cut hair accumulates is generally round, flat, and easy to clean.

In foil shavers, mechanical features for exposing the space where cut hair is collected are also provided. However, in foil shavers, the space within which cut hair accumulates is typically much larger than the space associated with each individual cutting assembly of a rotary shaver. This larger area can be difficult to clean, as the cut hair has a relatively large amount of surface area to cling to.

Further, in a typical method of cleaning foil shavers, one must first separate the outer cutter from the inner cutter, and then separately brush or rinse off the surfaces of the outer cutter and the inner cutter which have collected cut hair. Brushing in many cases leaves a considerable amount of cut hair behind, and this is compounded when multiple components must be separately cleaned.

Rinsing also has drawbacks in foil shavers, as the rinsing action typically forces some cut hair into areas that are difficult to clean or forces the cut hair back against an interior of the foil structure of the outer cutter depending on the direction of rinsing fluid flow. In either case of brushing or rinsing, some cut hair is removed, but an undesirable amount may remain.

Still further, in many contemporary foil shaver designs, the inner cutter is movable relative to the outer cutter by way of a drive linkage. This drive linkage is typically exposed, at least in part, to the area in which the cut hair accumulates within the device. This can be problematic, as a substantial accumulation of cut hair around the moving componentry of the drive linkage can cause a reduction in performance.

Accordingly, there is a need for an improved electric shaver with provisions for easily removing cut hair from the space in which it is collected.

### SUMMARY

In one aspect, embodiments of the invention provide an electric shaver with enhanced cleaning features. The enhanced cleaning features provide for cleaning of cut hair from a hair containment space of the electric without disassembly of a cutting assembly of the electric shaver, unlike prior designs. Further, in a particular embodiment of the invention, the hair containment space is separated from a maintenance space such that the ingress of cut hair into the maintenance space is substantially reduced.

One embodiment of an electric shaver according to this aspect includes a housing and a motor carried by the housing. A drive linkage is operably connected to the motor to transfer a mechanical load from the motor. A cutting is head situated at an end of the housing and operably connected to the drive linkage to produce a hair cutting action. The cutting head includes at least one cutting assembly. The at least one cutting assembly includes an outer cutter extending along a longitudinal axis. The cutting assembly also includes an inner cutter movable within the passageway in a cutting direction parallel to the longitudinal axis of the passageway to produce the hair cutting action. A passageway extends through the at least one cutting assembly to define a drainage flow path for a fluid passing through the passageway in a direction parallel to the cutting direction.

In an embodiment, the cutting head includes a first longitudinal side and a second longitudinal side parallel to the first longitudinal side. The cutting head further includes a first lateral side and a second lateral side parallel to the first lateral side. The first and second lateral sides extend between the first and second longitudinal sides of the cutting head. The passageway includes a first opening at the first lateral side and a second opening at the second lateral side of the cutting head.

The at least one cutting assembly extends between the first and second lateral sides of the cutting head in a direction parallel the first longitudinal side of the cutting head. In an embodiment, the at least one cutting assembly includes two cutting assemblies arranged in a parallel arrangement. In an embodiment, the inner cutter is movable within the passageway to perform the hair cutting action while the fluid passes through the passageway.

In an embodiment, the outer cutter of the at least one cutting assembly comprises a support structure and a cutting element supported by the support structure. The support structure includes a first longitudinal side, a second longitudinal side in opposed spaced relation to the first longitudinal side, a first lateral side, and a second lateral side in opposed spaced relation to the first lateral side. The first and second lateral sides extend between the first and second longitudinal sides of the support structure. The passageway extends between the first and second lateral sides of the support structure. An opening is formed through each of the first and second lateral sides and each opening forms part of the passageway. The openings of each of the first and second lateral sides of the support structure have a semi-circular periphery in one embodiment. In an embodiment, the cutting head includes a chassis. The outer cutter of the at least one cutting assembly is mounted to the chassis such that the opening formed through each of the first and second lateral sides of the outer cutter extend past an upper-most edge of the chassis.

In an embodiment, the housing includes an intermediary wall interposed between the passageway and a maintenance space of the housing. The intermediary wall extends between the first and second lateral sides of the cutting head and adjacent the passageway such that a hair containment space is formed in the cutting head. The inner cutter is movable within the hair containment space in the hair cutting direction.

In an embodiment, the housing includes a main body and a cap. The cap is removable from the main body for access to the maintenance space. The cutting head is removably attached to the cap such that attachment of the cutting head to the cap forms the hair containment space. The cap and cutting head are removable from the housing as a unit, such that the hair containment space is removable from the housing.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a top perspective view of an embodiment of an electric shaver constructed in accordance with the teachings herein;

FIG. 2 is a perspective exploded view of the electric shaver of FIG. 1, depicting the componentry of a cutting head of the electric shaver;

FIG. 3 perspective cross section of the electric shaver of FIG. 1;

FIG. 4 is a perspective exploded view of an outer cutter of a cutting assembly of the cutting head of the electric shaver of FIG. 1; and

FIG. 5 is a plan view of the electric shaver of FIG. 1 showing a drainage functionality thereof.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION

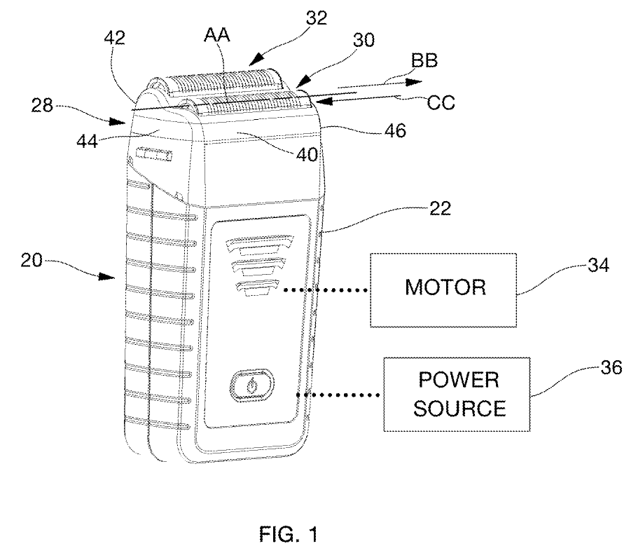

Turning now to the drawings, FIG. 1 illustrates an exemplary embodiment of an electric shaver embodied 20. As will be described in greater detail below, shaver 20 is advantageously provided with a passageway defining a fluid flow path through a cutting head 28 to facilitate cleaning without the need to disassemble the unit. Additionally, shaver 20 is provided with a hair containment space that is separate from a maintenance space such that ingress of cut hair and debris into the maintenance space is substantially reduced or eliminated entirely.

Shaver 20 includes a housing 22 and a cutting head 28. Cutting head 28 includes at least one cutting assembly 30. In the illustrated embodiment, two cutting assemblies 30, 32 are shown. As those skilled in the art will appreciate, the teachings herein can be applied to a single cutting assembly 30, or more than two cutting assemblies 30, 32. Cutting assemblies 30, 32 are identical, and as such, a description herein relative to cutting assembly 30 applies equally well to cutting assembly 32.

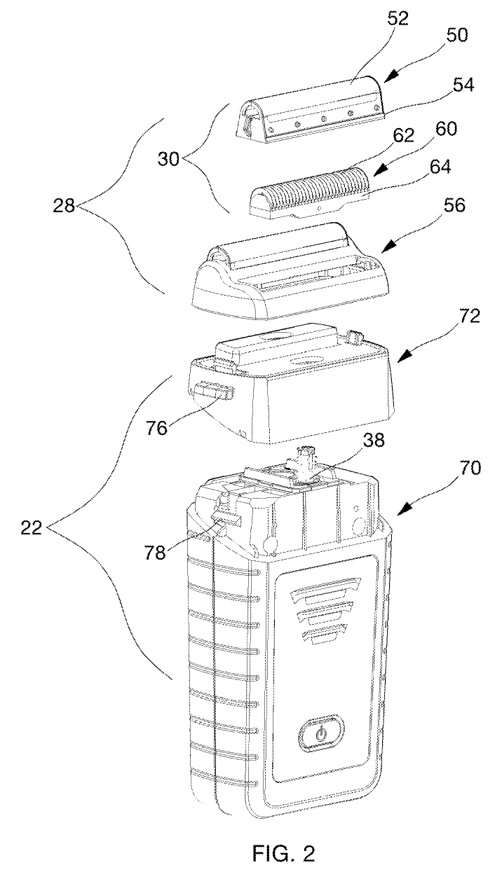

Shaver 20 also includes an internal electric motor 34 that draws power from a power source 36. Power source 36 may be an internal battery and/or electrical power supplied at a wall outlet. A drive linkage 38 (see FIG. 2) is connected between motor 34 and cutting head 28 to produce a hair cutting action as described below. Drive linkage 38 may for example be embodied as a drive finger assembly such as that described in United States Patent Application Serial No. 17/458,902 titled “Shaver” to Arndt et al. filed on Aug. 27, 2021, published as United States Patent Application Publication No. 20230064384A1 (hereinafter the ‘902 application) and assigned to the Applicant herein, the disclosure of which is hereby incorporated by reference in its entirety as if fully set forth herein.

Cutting head 28 includes generally parallel first and second longitudinal sides 40, 42. Cutting head 28 also include generally parallel first and second lateral sides 44, 46 which extend between first and second longitudinal sides 40, 42. As shown in FIG. 1, cutting assemblies 30, 32 extend between first and second lateral sides 44, 46 and are generally parallel to first or second longitudinal sides 40, 42.

Turning now to FIG. 2, cutting assembly 30 includes an outer cutter 50 extending along a longitudinal axis AA as shown in FIG. 1. Outer cutter 50 includes a cutting element 52 and a support structure 54. In the illustrated embodiment, cutting element 52 is attached to support structure 54 and may be embodied as a flexible foil structure. In such an embodiment, cutting element 52 may include a plurality of openings (not shown) for hair to pass through. As is appreciated by those of skill in the art, these openings may take on a variety of geometries to promote hair presentation for cutting.

Support structure 54 may be a frame like structure and may be removable from a chassis 56 of cutting head 28 in a same or similar manner as that described in the ‘902 Application incorporated by reference herein. Advantageously, this removable functionality allows for replacement of outer cutter 50 when desirable. Alternatively, outer cutter 50 may be integrally formed with chassis 56 such that cutting element 52 is supported directly by chassis 56, thereby omitting a separate support structure 54.

Cutting assembly 30 also includes an inner cutter 60 arranged to reciprocate in cutting directions BB, CC parallel to longitudinal axis AA as is also shown in FIG. 1. As is recognized by those of skill in the art, inner cutter 60 moves in direction BB, CC relative to outer cutter 50 to perform the hair cutting action. Inner cutter 60 includes a cutting element 62 carried by a support structure 64. Cutting element 62 is illustrated as a plurality of upstanding blades, however, it may take on any geometry understood by those of skill in the art to cut hair as inner cutter 60 moves relative to outer cutter 50. Inner cutter 60 may also be removable from cutting head 28 via a lug attachment between support structure 64 and drive linkage 38, as is shown and described in the ‘902 Application incorporated by reference herein.

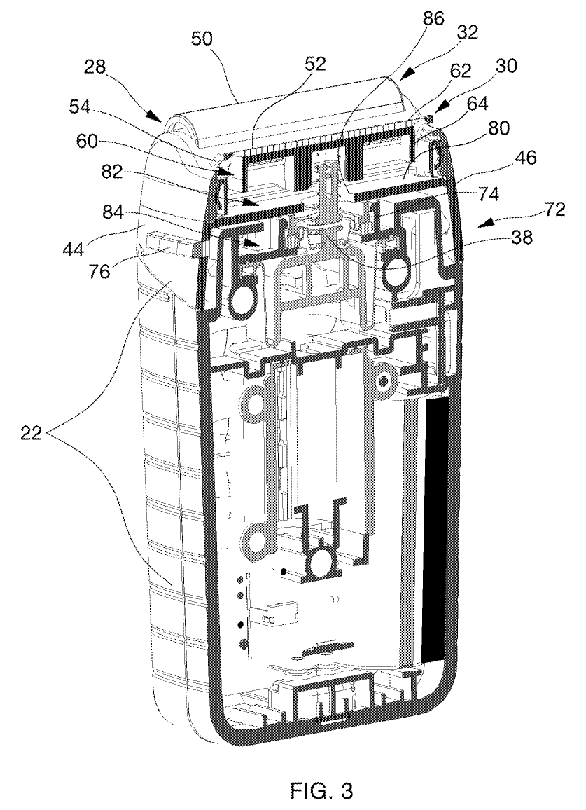

Still referring to FIG. 2, housing 22 includes a main body 70 and a cap 72 removably attached to main body 70. This functionality may be achieved via a depressible button and spring-loaded retaining tab (not shown) located on a side of housing 22. Removing 72 from main body 70 exposes a maintenance space (described below) for access to a portion of a seal arrangement 74 (see FIG. 3)and the above referenced drive linkage 38. Seal arrangement 74 may be embodied as the seal arrangement described in the ’902 Application incorporated by reference herein. Advantageously, exposing the maintenance space allows the user to clean out the maintenance space, lubricate or replace seal arrangement 74, and/or lubricate or replace portions of drive linkage 38.

Cutting head 28 is removably attached to cap 72. This functionality may be achieved via a depressible button 76 and spring-loaded retaining tab 78 located on a side of cap 72 and housing 22, respectively. While a single button 76 is shown in the illustrated embodiment, it is contemplated that a dual button configuration may also be utilized having the same button 76 construction on both sides of cap 72. In either such arrangement, both cutting head 28 and cap 72 are removable as a unit from main body 70. Also with such an arrangement, cutting head 28 is removable as a stand-alone assembly from cap 72. Alternatively, it is also contemplated that cutting head 28 is the only component removable from housing 22. In other words, it is contemplated that cap 72 may not be removable and instead be integrally formed with housing 22.

Turning now to FIG. 3, the same illustrates a cross section through cutting head 28. As may be seen in FIG. 3, cap 72 provides an intermediary wall 80 that extends between first and second lateral sides 44, 46 of cutting head 28. Intermediary wall 80 separates a hair containment space 82 from the above referenced maintenance space 84. Hair containment space 82 is the area above intermediary wall 80 and below an interior surface of cutting element 52 of outer cutter 50, within which inner cutter 60 is movable to perform the hair cutting action. Maintenance space 84 is the area below intermediary wall 80 and above an end wall 86 of main body 70 of housing 22.

Intermediary wall 80 functions to substantially reduce or prevent ingress of cut hair contained in hair containment space 82 into maintenance space 84. Indeed, intermediary wall 80 separates hair containment space 82 from maintenance space 84 but for a relatively small opening 86 through which a portion drive linkage 38 extends. While not shown, it is within the teachings herein to include a seal around opening 86 to prevent the relatively small amount of cut hair and debris that may pass through opening 86. Further, as may be seen from inspection of FIG. 3, intermediary wall 80 is generally flat. As a result, cut hairs and debris have a generally regular and uniform surface to collect upon, making the removal of same easier than in prior designs where a variety of geometries are presented in the hair containment space.

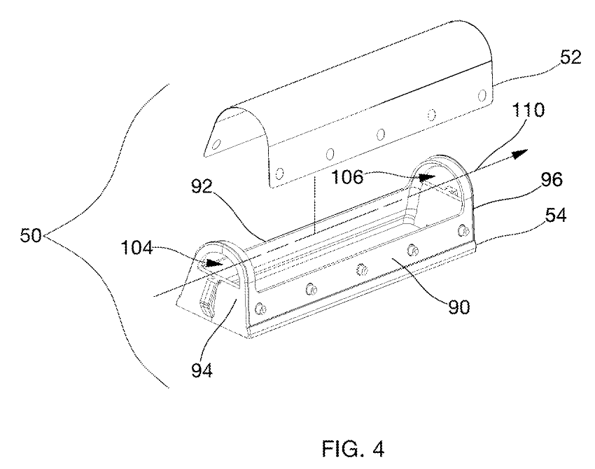

With reference now to FIG. 4, the same illustrates outer cutter 50 in an exploded view. Support structure 54 includes first longitudinal side 90 and a second longitudinal side 92 parallel to first longitudinal side 90. Support structure 54 also includes a first lateral side 94 and second lateral side 96 parallel to first lateral side 94. First lateral side 94 includes an opening 104 as shown. Second lateral side 96 also includes an opening 106 as shown. Openings 104, 106 and the space between first and second lateral sides 94, 96 form a passageway 110 which defines a fluid flow path through cutting assembly 30 (see FIG. 1). As mentioned above cutting assembly 32 is identical to cutting assembly 30, and as such, a like passageway extends through cutting assembly 32 (see FIG. 1).

In the illustrated embodiment, openings 104, 106 are semi-circular in shape. However, in other embodiments, openings 104, 106 may take on any shape sufficient to allow for fluid flow through passageway 110. Openings 104, 106 may, for non-limiting example, include orifice geometry that encourages flow characteristics (e.g. turbulent flow, laminar flow, etc.) through passageway 110.

Passageway 110 allows for a fluid, e.g. water, air, cleaning compounds, etc., to flow through cutting assembly 30 in a direction generally parallel to cutting directions AA, BB (see FIG. 1). As may be seen with momentary reference to FIG. 1, openings 104, 106 extend past an upper most edge of chassis 56 (see FIG. 2) such that they are exposed when shaver 20 is fully assembled and operational, thereby placing hair containment space 82 (see FIG. 3) in fluid communication with an exterior of shaver 20. In other embodiments, first and second lateral sides 44, 46 of cutting head 28 may extend higher and be provided with their own openings aligned with openings 104, 106 and in that case would also form a part of passageway 110.

It is also envisioned that, in embodiments wherein cutting element 52 is directly supported on chassis 56 (see FIG. 2) as opposed to on support structure 54, chassis 56 may itself include openings like openings 104, 106 on first and second lateral sides 44, 46 (see FIG. 2) to form a passageway like passageway 110. In such an embodiment, first and second lateral sides 44, 46 may each include a single opening that allows the ingress of cleaning fluid into multiple hair containment spaces, such as where multiple cutting assemblies are employed (see e.g. FIG. 1 cutting assemblies 30, 32). It is also envisioned that multiple openings may be provided at each end of passageway 110, as opposed to a single opening as shown. Further, and with momentary reference back to FIG. 2, cutting element 62 of inner cutter 60 may be provided with holes or the like aligned with passageway 110. In this way any restriction to fluid flow created by cutting element 62 is reduced.

Although not shown, it is also contemplated that coverings could be provided for openings 104, 106 such that a user may selectively close passageway 110. This may be desirable in cases where the user prefers to cover openings 104, 106 until they are ready to clean cutting assembly 30. Such coverings could simply be removable plugs, or, be embodied as mechanical features integrated into cutting head 28 (e.g. slidable doors, etc.).

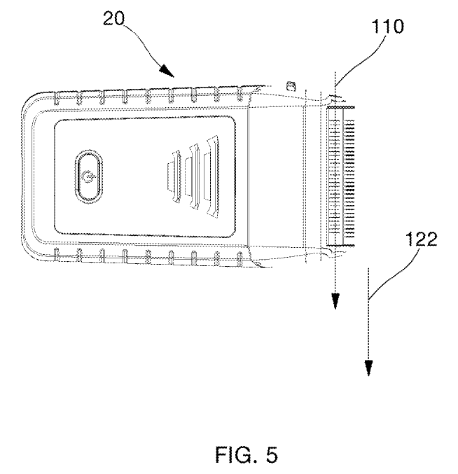

Turning now to FIG. 5, passageway 110 is arranged such that it may oriented parallel to a cleaning fluid flow direction 122. For non-limiting example, passageway 110 may be easily oriented to be parallel with a flow a water from a faucet under gravity. In this way, cut hair and debris is encouraged to flow with cleaning fluid under gravity through passageway 110. Because this flow of cleaning fluid may occur while shaver 20 is fully assembled, it is possible to power on the unit and allow inner cutter 60 to move relative to outer cutter 50 to enhance the removal of cut hair and debris.

All references, including publications, patent applications, and patents cited herein are hereby incorporated by reference to the same extent as if each reference were individually and specifically indicated to be incorporated by reference and were set forth in its entirety herein.

The term “electric hair cutting device” as used herein includes any electric hair cutting device that includes a motor which drives a moving blade to cut hair, including but not limited to hair clippers, hair trimmers, and electric shavers, for human or for animal application. The terms “hair clipper” and “hair trimmer” are used interchangeably unless otherwise noted, and do not limit the scope or applicability of the invention herein to either particular variant.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,”“having,”“including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Embodiments of this invention are described herein, including the best mode known to the inventors for carrying out the invention. Variations of those embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An electric shaver, comprising:
a housing;
a motor carried by the housing;
a drive linkage operably connected to the motor to transfer a mechanical load from the motor;
a cutting head situated at an end of the housing and operably connected to the drive linkage to produce a hair cutting action, the cutting head including at least one cutting assembly, the at least one cutting assembly comprising:
an outer cutter extending along a longitudinal axis; and
an inner cutter movable within the passageway in a cutting direction parallel to the longitudinal axis to produce the hair cutting action; and
wherein passageway extends through the at least one cutting assembly to define a drainage flow path for a fluid passing through the passageway in a direction parallel to the cutting direction.

2. The electric shaver of claim 1, wherein the cutting head includes a first longitudinal side and a second longitudinal side parallel to the first longitudinal side, the cutting head further including a first lateral side and a second lateral side parallel to the first lateral side, the first and second lateral sides extending between the first and second longitudinal sides, wherein the passageway includes a first opening at the first lateral side and a second opening at the second lateral side of the cutting head.

3. The electric shaver of claim 2, wherein the at least one cutting assembly extends between the first and second lateral sides of the cutting head in a direction parallel the first longitudinal side of the cutting head.

4. The electric shaver of claim 3, wherein the at least one cutting assembly includes two cutting assemblies arranged in a parallel arrangement.

5. The electric shaver of claim 1, wherein the outer cutter of the at least one cutting assembly comprises a support structure and a cutting element supported by the support structure, wherein the support structure includes a first longitudinal side, a second longitudinal side in opposed spaced relation to the first longitudinal side, a first lateral side, and a second lateral side in opposed spaced relation to the first lateral side, the first and second lateral sides extending between the first and second longitudinal sides.

6. The electric shaver of claim 5, wherein the passageway extends between the first and second lateral sides of the support structure, wherein an opening is formed through each of the first and second lateral sides and each form part of the passageway.

7. The electric shaver of claim 6, wherein the openings of each of the first and second lateral sides of the support structure have a semi-circular periphery.

8. The electric shaver of claim 6, wherein the cutting head further comprises a chassis, wherein the outer cutter of the outer cutter of the at least one cutting assembly is mounted to the chassis such that the opening formed through each of the first and second lateral sides of the outer cutter extend past an upper-most edge of the chassis.

9. The electric shaver of claim 2, wherein the housing comprises an intermediary wall, the intermediary interposed between the passageway and a maintenance space of the housing.

10. The electric shaver of claim 9, wherein the intermediary wall extends between the first and second lateral sides of the cutting head and adjacent the passageway such that a hair containment space is formed in the cutting head.

11. The electric shaver of claim 10, wherein the inner cutter is movable within the hair containment space in the hair cutting direction.

12. The electric shaver of claim 11, wherein housing includes a main body and a cap, the cap removable from the main body for access to the maintenance space.

13. The electric shaver of claim 12, wherein the cutting head is removably attached to the cap such that attachment of the cutting head to the cap forms the hair containment space.

14. The electric shaver of claim 13, wherein the cap and cutting head are removable from the housing as a unit, such that the hair containment space is removable from the housing.

15. The electric shaver of claim 1, wherein the inner cutter is movable within the passageway to perform the hair cutting action while the fluid passes through the passageway.
